(19) United States
(12) Patent Application Publication
(10) Pub. No.: US 2024/0068105 A1
(43) Pub. Date: Feb. 29, 2024

(54) METHOD FOR ETCHING AT LEAST ONE SURFACE OF A PLASTIC SUBSTRATE

(71) Applicant: Atotech Deutschland GmbH & Co. KG, Berlin (DE)

(72) Inventors: Rafael-Eduard SZAMOCKI, Berlin (DE); Franziska FINN, Berlin (DE); Carl Christian FELS, Berlin (DE)

(73) Assignee: Atotech Deutschland GmbH & Co. KG, Berlin (DE)

(21) Appl. No.: 18/258,040

(22) PCT Filed: Dec. 17, 2021
(86) PCT No.: PCT/EP2021/086440

§ 371 Date: Jun. 16, 2023

(30) Foreign Application Priority Data
Dec. 18, 2020 (EP) 20215535.4

(51) Int. Cl. C23C 18/24; C23C 18/16; C23C 18/20; C23C 28/02; C25D 3/12; C25D 3/38; C25D 5/14; C25D 5/56

(52) U.S. Cl. CPC C23C 18/24; C23C 18/1641; C23C 18/1651; C23C 18/1653; C23C 18/2086; C23C 28/023; C25D 3/12; C25D 3/38; C25D 5/14; C25D 5/56

(57) ABSTRACT

The present invention relates to a method for etching at least one surface of a plastic substrate, the method comprising the steps (A) to (C), wherein step (C) is an etching step including a contacting with an etching composition. The etching composition comprises permanganate ions and phosphoric acid, each in specifically defined concentration ranges.

### FIELD OF THE INVENTION

The present invention relates to a method for etching at least one surface of a plastic substrate, the method comprising the steps (A) to (C), wherein step (C) is an etching step including a contacting with an etching composition. The etching composition comprises permanganate ions and phosphoric acid, each in specifically defined concentration ranges.

### BACKGROUND OF THE INVENTION

Metallizing non-metallic substrates such as plastic substrates has a long history in modern technology. Typical applications are found in automotive industry as well as for sanitary articles.

However, making a non-metallic/non-conductive substrate receptive for a metal layer is demanding. Typically, a respective method starts with a surface modification of the substrate's surface, typically known as etching. Usually, a sensitive balance is required in order to ensure a sufficient surface roughening without causing too strong defects.

Many methods and etching compositions are known, including compositions comprising environmentally questionable chromium species, such as hexavalent chromium species (e.g. chromic acid). Although these compositions usually provide very strong and acceptable etching results, environmentally friendly alternatives are more and more demanded and to a certain extent already provided in the art. In many cases manganese-based etching compositions are utilized instead.

For example, EP 2 025 708 A1 refers to a manganese containing etching composition comprising phosphoric acid.

U.S. Pat. No. 3,647,699 A refers to a surface conditioner composition for ABS resin. The composition includes orthophosphoric acid and permanganate ions.

U.S. Pat. No. 9,023,228 B2 refers to pickling solution and to a process for pickling plastic surfaces including an oxidation cell.

EP 1 001 052 A2 refers to a method for metalizing a resin surface. The method includes a step of contacting a substrate with a mild etching solution comprising permanganate as well as phosphoric acid and/or sulfuric acid.

It is a very preferred goal to obtain etching results very similar or even identical to chromic acid etches. However, this is not easy to achieve. Even if the chemical etching is almost identical, often a higher number of steps are needed to achieve it compared to previously used chromic acid etching. If so, a simple replacement of the former technology with a new one cannot be easily made. Very often additional space is needed in a facility in order to house for example additional tanks and rinse lines. Therefore, there is an ongoing demand to further improve known manganese-based etching compositions and respective etching processes.

Objective of the present Invention

It is therefore the objective of the present invention to overcome the above mentioned shortcomings of the prior art.

It is in particular an objective of the present invention to provide a method for etching at least one surface of a plastic substrate, which can be easily implemented in existing plating lines and at the same time provides etching results very similar to etching results obtained from chromic acid etching compositions.

It is furthermore an objective that the etched substrate can be flexibly used in various und very different subsequent metallization processes.

It is a further objective of the present invention to allow a selective etching on 2-component substrates (i.e. 2K substrates), wherein one component is preferably polycarbonate (PC), more preferably transparent/translucent PC, without etching PC but rather only the other component.

### SUMMARY OF THE INVENTION

Above mentioned objectives are solved by a method for etching at least one surface of a plastic substrate, the method comprising the steps
(A) providing the substrate,
(B) optionally, contacting the provided substrate with one or more than one pre-treatment composition,
(C) contacting the substrate obtained after step (A) or (B) with an etching composition such that an etched substrate results, the etching composition comprising
   (a) water,
   (b) 0.0025 mol/L to 0.1 mol/L permanganate ions,
   (c) 7 mol/L to 12 mol/L phosphoric acid,
   (d) 0 to 0.1 mol/L silver (1) ions, and
   (e) 0 or less than 10 ppm manganese (II) ions,
   wherein at least during step (C) at least a portion of the permanganate ions is converted into manganese species having an oxidation number below +7.

In the context of the present invention, concentrations in mol/L or mmol/L are based on the total volume of the etching composition, if not stated otherwise.

Own experiments have shown (see examples below in the text) that the method of the present invention results in an etching pattern very similar or even identical to an etching pattern obtained with a chromic acid etching composition.

Furthermore, our experiments show that the method of the present invention can easier replace existing chromic acid etching lines because a swelling step prior to the etching step can generally be avoided. In many cases this means that respective compartments/containers/tanks are not needed in a respective plating line.

In addition, the method of the present invention allows a high flexibility on how to proceed in subsequent metallization steps. Substrates etched with the method of the present invention can either be further metallized with nickel (e.g. with Watts nickel) or with immersion copper (also sometimes named “replacement plating”, wherein in this particular case a less noble metal is replaced by the more electrochemical active copper without using a reducing agent). These two metallization options cover a great variety of possible applications.

Another great benefit of the method of the present invention is selectivity. Own experiments have shown that the etching composition utilized in the method of the present invention allows a selective etching of 2K substrates comprising PC. In such a case, PC is not etched but rather the other component, e.g. acrylonitrile butadiene styrene (ABS) or acrylonitrile butadiene styrene—polycarbonate (ABS-PC).

All these advantages were not expected and thus surprising. However, they are only achieved if the above mentioned concentration ranges for permanganate ions and phosphoric acid are maintained.

### DETAILED DESCRIPTION OF THE INVENTION

The method of the present invention primarily includes a contacting with a specific pre-etching composition in order to obtain a well etched plastic substrate.

Step (A): providing the substrate:

In step (A) the substrate is provided.

Preferred is a method of the present invention, wherein the plastic substrate comprises butadiene moieties, preferably polybutadiene.

Also preferred is a method of the present invention, wherein the plastic substrate comprises nitrile moieties.

Also preferred is a method of the present invention, wherein the plastic substrate comprises acryl moieties.

Also preferred is a method of the present invention, wherein the plastic substrate comprises styrene moieties.

More preferred is a method of the present invention, wherein in step (A) the substrate comprises acrylonitrile butadiene styrene (ABS), acrylonitrile butadiene styrene—polycarbonate (ABS-PC), polypropylene (PP), polyamide (PA), polyetherimide (PEI), a polyetherketone (PEK), epoxy resins, mixtures or composites thereof.

Preferred is a method of the present invention, wherein the polyetherketone (PEK) comprises polyaryletherketone (PAEK), poly ether ether ketone (PEEK), poly ether ether ether ketone (PEEEK), poly ether ether ketone ketone (PEEKK), poly ether ketone ether ketone ketone (PEKEKK), poly ether ketone ketone (PEKK), and/or mixtures thereof, preferably poly ether ether ketone (PEEK), polyaryletherketone (PAEK), and/or mixtures thereof.

In some cases, very preferred is a method of the present invention, wherein the substrate comprises a 2-component (2K) substrate, preferably comprising polycarbonate (PC) as one component. A preferred 2K substrate comprises polycarbonate/acrylonitrile butadiene styrene—polycarbonate (PC/ABS-PC) and/or polycarbonate/acrylonitrile butadiene styrene (PC/ABS). The etching composition utilized in the method of the present invention selectively etches the ABS and ABS-PC without etching the PC component.

In some cases, a 2K-substrate is preferred, wherein one component is transparent, preferably the 2K-substrate comprises transparent polycarbonate (PC).

Step (B): optionally, contacting the provided substrate with one or more than one pre-treatment composition:

In many cases, a method of the present invention is preferred, wherein the contacting is carried out, i.e. is not optional.

Preferred is a method of the present invention, wherein in step (B) the one or more than one pre-treatment composition comprises a cleaning composition.

The one or more than one pre-treatment composition preferably utilized in the method of the present invention comprises water. Most preferably, water is the only solvent in the one or more than one pre-treatment composition.

Preferred is a method of the present invention, wherein step (B) does not comprise a swelling step. Thus, preferred is a method of the present invention, wherein the one or more than one pre-treatment composition does not comprise a swelling composition.

Thus, preferred is a method of the present invention, wherein in step (C) the substrate is not a swelled substrate.

Preferred is a method of the present invention, wherein in step (B) the one or more than one pre-treatment composition does not comprise gamma-butyrolactone, preferably does not comprise a lactone.

Preferred is a method of the present invention, wherein in step (B) the one or more than one pre-treatment composition does not comprise 2-butoxyethanol (i.e. ethylene glycol monobutyl ether, EGBE), preferably does not comprise an ether.

Preferred is a method of the present invention, wherein in step (B) the one or more than one pre-treatment composition does not comprise (preferably is not) an organic alcohol, preferably does not comprise (preferably is not) an organic solvent.

Preferred is a method of the present invention, wherein step (B) does not comprise a contacting with a pre-treatment composition comprising an organic solvent, preferably does not comprise a contacting with an organic solvent-pre-treatment composition.

The aforementioned specific organic solvents and general groups of organic solvents, respectively, are typically used for swelling. However, in the context of the present invention, such a swelling step or sweller chemical, respectively, is not needed in order to obtain a well etched substrate. Such a step is therefore preferably omitted, most preferably for ABS containing substrates.

Step (C): contacting the substrate obtained after step (A) or (B) with an etching composition such that an etched substrate results:

In step (C) of the method of the present invention the provided substrate or the pre-treated substrate is contacted with the etching composition.

The etching composition utilized in the method of the present invention comprises
(a) water,
(b) 0.0025 mol/L to 0.1 mol/L permanganate ions,
(c) 7 mol/L to 12 mol/L phosphoric acid,
(d) 0 to 0.1 mol/L silver (1) ions, and
(e) 0 or less than 10 ppm manganese (II) ions.

Preferred is a method of the present invention, wherein (a), (b), (c), (d), and (e) form 90 wt. % or more of the total weight of the aqueous etching composition, preferably 92 wt.-% or more, more preferably 94 wt.-% or more, even more preferably 96 wt.-% or more, most preferably 98 wt.-% or more.

Preferred is a method of the present invention, wherein the etching composition is substantially free of, preferably does not comprise, a methane sulfonic acid and salts thereof, preferably substantially free of, preferably does not comprise, a C1 to C4 alkyl sulfonic acid and salts thereof, most preferably is substantially free of, preferably does not comprise, a C1 to C4 sulfonic acid and salts thereof.

Preferred is a method of the present invention, wherein the etching composition is substatially free of, preferably does not comprise, bromide and iodide anions, preferably is substantially free of, preferably does not comprise, chloride, bromide, and iodide anions, most preferably is substantially free of, preferably does not comprise, halide anions.

Preferred is a method of the present invention, wherein the etching composition is substantially free of, preferably does not comprise, trivalent chromium ions and hexavalent chromium compounds, preferably is substantially free of, preferably does not comprise, any compounds and ions comprising chromium.

Preferred is a method of the present invention, wherein the etching composition is substantially free of, preferably does not comprise, sulfuric acid.

Preferred is a method of the present invention, wherein in step (C) in the etching composition manganese (II) ions have a total concentration of zero. This is most preferred. However, in some cases a total concentration is preferred (and still accepted) ranging from 0.1 ppm to 9 ppm, based on the total weight of the etching composition, preferably from 0.5 ppm to 8 ppm, more preferably from 1 ppm to 7 ppm, even more preferably from 1.5 ppm to 6 ppm, most preferably from 2 ppm to 5 ppm.

More preferred is a method of the present invention, wherein in step (C) in the etching composition the manganese (11) ions have a concentration of 9 ppm or less, preferably of 8 ppm or less, more preferably of 7 ppm or less, even more preferably of 6 ppm or less, most preferably of 5 ppm or less.

Generally, manganese (II) ions are an undesired by-product of the method of the present invention.

In the presence of phosphoric acid, permanganate ions are typically unstable and decompose to manganese species having an oxidation number below +7. Own experiments have shown that the decomposition rate strongly depends on the concentration of phosphoric acid. This decomposition is even stronger if permanganate ions oxidize chemical compounds in the substrate in order to etch the substrate's surface. As a result, at least a portion of the permanganate ions is additionally converted into manganese species having an oxidation number below +7.

In order to run the method of the present invention continually, new or fresh permanganate ions must be added, i.e. replenished. A method of the present invention is therefore preferred, wherein the method is carried out continually. This most preferably applies to all steps defined in the context of the present invention.

Preferred is a method of the present invention, wherein step (C) comprises step
(C-1) replenishing permanganate ions to the etching composition utilized in step (C).

Typically, there is more than one way in order to run the method of the present invention continually.

In some cases, a re-oxidation of permanganate species having an oxidation number below +7 is preferably applied, more preferably chemically (chemical re-oxidation) or by applying an external electrical current (electrolytic re-oxidation). In this way permanganate ions are recycled and are preferably replenished and re-used, respectively.

In many cases a method of the present invention is preferred, wherein
at least a portion of the manganese species having an oxidation number below +7 is treated in a regeneration compartment and an electrical current is applied such that they are re-oxidized to permanganate ions, and
permanganate ions replenished in step (C-1) are those re-oxidized in the regeneration compartment.

This approach is most preferred.

Preferred is a method of the present invention, wherein the electrical current is a direct current, preferably having a current density ranging from 0.1 A/dm² to 10 A/dm², preferably from 0.2 A/dm² to 7.5 A/dm², more preferably from 0.3 A/dm² to 5 A/dm², even more preferably from 0.4 A/dm² to 2.5 A/dm², most preferably from 0.5 A/dm² to 1 A/dm². Very preferred is a current density ranging from 0.1 A/dm² to 2 A/dm², more preferably from 0.2 A/dm² to 1 A/dm², most preferably from 0.3 A/dm² to 0.8 A/dm².

Preferred is a method of the present invention, wherein the manganese species having an oxidation number below +7 are treated in the regeneration compartment at a temperature ranging from 20° C. to 65° C., preferably from 25° C. to 60° C., more preferably from 30° C. to 55° C., most preferably 35° C. to 50° C., even most preferably from 37° C. to 43° C.

In some other cases, a portion of the etching composition is removed and a portion of fresh solubilized permanganate ions is replenished (also often referred to as “bleed and feed” approach). However, without any recycling of the removed etching bath components this approach is producing a significant amount of waste. Although this approach is technically possible, it is less preferred in the context of the present invention.

Thus, in some cases a method of the present invention is preferred, wherein
at least a portion of the manganese species having an oxidation number below +7 is removed from the etching composition by removing at least a portion of the etching composition, and
permanganate ions replenished in step (C-1) are from an alkali permanganate salt.

Preferred is a method of the present invention, wherein the etching composition is strongly acidic, preferably has a pH of 2 or below, more preferably of 1 or below, even more preferably of 0.5 or below, most preferably of zero or below.

The etching composition utilized in the method of the present invention comprises water.

Preferred is a method of the present invention, wherein in the etching composition the balance is water. Preferably, the water has a concentration ranging from 10.8 mol/L to 27.5 mol/L, preferably from 12 mol/L to 26 mol/L, more preferably from 13.1 mol/L to 24.5 mol/L, even more preferably from 13.9 mol/L to 23.3 mol/L, most preferably from 14.7 mol/L to 22.6 mol/L.

Preferred is a method of the present invention, wherein in the etching composition the permanganate ions have a concentration ranging from 0.004 mol/L to 0.09 mol/L, preferably from 0.005 mol/L to 0.075 mol/L, more preferably from 0.006 mol/L to 0.06 mol/L, even more preferably from 0.007 mol/L to 0.045 mol/L, yet even more preferably from 0.008 mol/L to 0.03 mol/L, most preferably from 0.009 mol/L to 0.019 mol/L.

Very preferred is a method of the present invention, wherein in the etching composition the permanganate ions have a concentration ranging from 0.004 mol/L to 0.02 mol/L, preferably from 0.005 mol/L to 0.019 mol/L, more preferably from 0.006 mol/L to 0.017 mol/L, even more preferably from 0.007 mol/L to 0.015 mol/L, most preferably from 0.008 mol/L to 0.013 mol/L. These specific concentration ranges provide optimal etching results although broader concentration ranges are basically possible. These very preferred ranges are most preferred if in step (C-1) a regeneration compartment and an electrical current is applied, i.e. in an electrolytic re-oxidation. If a regeneration compartment and an electrical current is applied, it is generally preferred that in the etching composition the permanganate ions have a concentration not exceeding 30 mmol/L, preferably not exceeding 27 mmol/L, more preferably not exceeding 24 mmol/L, even more preferably not exceeding 21 mmol/L, most preferably not exceeding 18 mmol/1, yet most preferably not exceeding 15 mmol/L. This most preferably applies in combination with the lower limits mentioned before.

Preferred is a method of the present invention, wherein in the etching composition the phosphoric acid has a concentration ranging from 7.4 mol/L to 11.8 mol/L, preferably from 7.8 mol/L to 11.5 mol/L, more preferably from 8.2 mol/L to 11.2 mol/L, even more preferably from 8.5 mol/L to 11 mol/L, most preferably from 8.7 mol/L to 10.8 mol/L.

Most preferred is a method of the present invention, wherein phosphoric acid is the only acid in the etching composition.

In some cases a method of the present invention is preferred, wherein in the etching composition the phosphoric acid has a concentration ranging from 9.8 mol/L to 11.2 mol/L, preferably from 10 mol/L to 11 mol/L, more preferably from 10.3 mol/L to 10.7 mol/L. This is in particular preferred in an “feed and bleed” approach.

In other cases a method of the present invention is preferred, wherein in the etching composition the phosphoric acid has a concentration ranging from 9.2 mol/L to 10.5 mol/L, preferably from 9.3 mol/L to 10.4 mol/L, more preferably from 9.4 mol/L to 10.3 mol/L. This is in particular preferred in a re-oxidation approach, most preferably in an electrolytic re-oxidation.

In some cases, a method of the present invention is preferred, wherein the etching composition comprises silver (I) ions. This is most preferred if a re-oxidation approach is used, most preferably in an electrolytic re-oxidation. Silver ions are preferably needed in order to better catalyze the electrolytic re-oxidation. However, silver (I) ions do not disturb in a “feed and bleed” approach.

Preferred is a method of the present invention, wherein in the etching composition the silver (I) ions have a concentration ranging from 0.0001 mol/L to 0.09 mol/L, preferably from 0.0002 mol/L to 0.07 mol/L, more preferably from 0.0005 mol/L to 0.05 mol/L, even more preferably from 0.0007 mol/L to 0.03 mol/L, most preferably from 0.001 mol/L to 0.01 mol/L, even most preferably from 0.0015 mol/L to 0.005 mol/L.

Preferred is a method of the present invention, wherein in step (C) in the etching composition the silver (1) ions are provided through a silver (1) salt and/or a soluble silver anode.

A preferred silver (1) salt comprises AgNO₃, Ag₂CO₃, Ag₃PO₄, AgOH, Ag₂O, and/or Ag₂SO₄.

As mentioned above, in particular during step (C) not only permanganate ions are present in the etching composition but also manganese species having an oxidation number below +7. All of them together form a total manganese concentration.

Preferred is a method of the present invention, wherein in the etching composition all manganese species together have a total concentration ranging from 0.02 mol/L to 0.3 mol/L, based on the total volume of the etching composition, preferably from 0.03 mol/L to 0.25 mol/L, most preferably from 0.035 mol/L to 0.2 mol/L. Very most preferred, in the etching composition all manganese species together have a total concentration ranging from 0.04 mol/L to 0.1 mol/L. This is very preferred in combination with an electrolytic re-oxidation. In the context of the present invention, it is a great benefit that for an electrolytic re-oxidation the total concentration of all manganese species together remains comparatively stable. As a matter of fact, besides replenishment of dragged-out manganese species, no manganese species are typically added to maintain the method. This typically stabilizes the entire method of the present invention.

Preferred is a method of the present invention, wherein in step (C) the etching composition has a density in a range from 1.15 g/cm³ to 1.51 g/cm³, referenced to a temperature of 25° C., preferably from 1.22 g/cm³ to 1.41 g/cm³, more preferably from 1.24 g/cm³ to 1.39 g/cm³, most preferably from 1.26 g/cm³ to 1.38 g/cm³.

Preferred is a method of the present invention, wherein the etching composition further comprises one or more than one surfactant. Surfactants are typically needed in order to increase wettability. There are no particular restrictions regarding the kind of surfactants. Thus, preferred are cationic surfactants, anionic surfactants, and/or non-ionic surfactants.

Preferred is a method of the present invention, wherein the one or more than one surfactant is present in the etching composition in a total concentration in a range from 0.001 g/L to 1.0 g/L, based on the total volume of the etching composition, preferably in a range from 0.005 g/L to 0.7 g/L, more preferably in a range from 0.01 g/L to 0.5 g/L, even more preferably in a range from 0.02 g/L to 0.3 g/L, most preferably in a range from 0.03 g/L to 0.15 g/L.

However, preferred is a method of the present invention, wherein the etching composition is substantially free of, preferably does not comprise, fluorinated surfactants, preferably is substantially free of, preferably does not comprise, fluorinated organic compounds. Since environmental restrictions are getting more and more demanding, fluorinated organic compounds, in particular fluorinated surfactants, are less desired.

The etching composition utilized in the method of the present invention is preferably set up with an alkaline permanganate salt, preferably sodium permanganate and/or potassium permanganate, preferably sodium permanganate. If a “feed and bleed” approach is used, such a permanganate salt is preferably also used to replenish permanganate ions. However, theoretically, the etching composition can also be set up by using only a manganese (II) salt und re-oxidizing manganese (II) ions in the regeneration compartment to obtain the etching composition that can be utilized in the method of the present invention. However, this case is less preferred.

Preferred is a method of the present invention, wherein the etching composition comprises alkali ions, most preferably sodium ions, preferably in a total amount ranging from 0.002 mol/L to 0.5 mol/L, based on the total volume of the etching composition, preferably 0.004 mol/L to 0.3 mol/L.

Preferred is a method of the present invention, wherein during step (C) the etching composition has a temperature ranging from 25° C. to 60° C., preferably from 28° C. to 55° C., more preferably from 30° C. to 50° C., even more preferably from 32° C. to 48° C., most preferably from 35° C. to 45° C.

Preferred is a method of the present invention, wherein step (C) is carried out for a time ranging from 1 minute to 120 minutes, preferably from 3 minutes to 90 minutes, more preferably from 5 minutes to 70 minutes, even more preferably from 6 minutes to 50 minutes, most preferably from 7 minutes to 35 minutes.

In some cases, a method of the present invention is preferred, wherein step (C) is carried out for a time ranging from 1 minute to 90 minutes, preferably from 2 minutes to 70 minutes, more preferably from 3 minutes to 50 minutes, even more preferably from 4 minutes to 30 minutes, most preferably from 5 minutes to 20 minutes. This is very preferred if an electrolytic re-oxidation is applied.

Preferred is a method of the present invention, wherein in step (C) primarily polybutadiene is pre-treated, preferably etched, if the substrate comprises, preferably is, acrylonitrile-butadiene-styrene (ABS) and/or acrylonitrile-butadiene-styrene-polycarbonate (ABS-PC), most preferably polybutadiene is more pre-treated, preferably etched, than the acrylonitrile styrene.

Preferred is a method of the present invention, wherein during step (C) substantially no, preferably no, manganese dioxide (MnO₂) is deposited onto the etched substrate. Thus, in the method of the present invention, no step is needed (and therefore not applied) in order to reduce manganese dioxide on the etched substrate; i.e. in order to dissolve MnO₂ by chemical reduction through a reducing agent. Thus, preferably, the etched substrate obtained after step (C) is not contacted with a respective composition comprising a reducing agent. Due to the specific composition of the etching composition and how it is utilized in the method of the present invention, such a step is not required. A typical rinsing with water is sufficient. In this regard, the number of steps is further reduced such that the method of the present invention can in many cases better replace commonly used chromic acid etch lines.

Therefore, preferred is a method of the present invention further comprising after step (C) a rinsing with water, more preferably a rinsing with water free of a reducing agent capable to chemically reduce manganese dioxide.

Further Steps:

After step (C), i.e. after etching the substrate, typically a metallization follows.

Preferred is a method of the present invention additionally comprising after step (C) the step
(D) contacting the etched substrate with an activation composition such that an activated substrate is obtained;
and/or (preferably and)
(E) contacting the etched substrate or the activated substrate (preferably the activated substrate) with a first metalizing composition such that a first metal or metal alloy layer is deposited thereon resulting in a first metalized substrate.

In this regard, the method of the present invention is preferably also a method for activating at least one surface of a plastic substrate, respectively, a method for metallizing at least one surface of a plastic substrate.

In the method of the present invention, preferably step (D) is a step separated and independent from step (C). In other words, the etching composition utilized in step (C) is not the activation composition utilized in step (D).

In step (D) of the method of the present invention, the etched substrate is contacted with an activation composition.

Preferred is a method of the present invention, wherein in step (D) the activation composition comprises palladium, preferably dissolved palladium ions or colloidal palladium, most preferably colloidal palladium. Preferably, the colloidal palladium comprises tin.

Preferred is a method of the present invention, wherein in step (D) the activation composition comprises palladium in a total concentration ranging from 20 mg/L to 200 mg/L, based on the total volume of the activation composition, preferably ranging from 40 mg/L to 150 mg/L, even more preferably from 50 mg/L to 110 mg/L, most preferably from 55 mg/L to 80 mg/L. Preferably, this total concentration includes both dissolved palladium ions and colloidal palladium. Above concentrations are based on the element palladium.

Preferred is a method of the present invention, wherein in step (D) the activation composition has a temperature ranging from 25° C. to 70° C., preferably from 30° C. to 60° C., even more preferably from 36° C. to 50° C., most preferably from 39° C. to 46° C.

Preferred is a method of the present invention, wherein in step (D) the contacting is carried out for a time ranging from 1 minute to 15 minutes, preferably from 2 minutes to 12 minutes, even more preferably from 3 minutes to 9 minutes, most preferably from 4 minutes to 7 minutes.

Preferred is a method of the present invention, wherein step (D) comprises step
(D-1) contacting the activated substrate with an accelerator composition to modify the activated substrate, the accelerator composition comprising
   no reducing agent but at least one complexing agent for tin ions, if in step (D) the activation composition comprises colloidal palladium, or
   a reducing agent for reducing palladium ions to metallic palladium, if in step (D) the activation composition comprises palladium ions but no colloidal palladium.

Preferred is a method of the present invention, wherein in step (D-1) the accelerator composition comprises no reducing agent but at least one complexing agent for tin ions and is acidic, preferably comprising in addition sulfuric acid.

In the context of the present invention, step (D-1) as defined above is carried out after contacting the etched substrate with an activation composition such that an activated substrate is obtained.

In step (E) of the method of the present invention, the etched substrate or the activated substrate is contacted with a first metalizing composition such that a first metal or metal alloy layer is deposited thereon resulting in a first metalized substrate.

Thus, step (E) either follows after the activation in step (D) or is applied to the etched substrate as a direct metallization, which does not require an activation. In the latter case, step (D) is not needed. However, preferred is a method of the present invention, wherein steps (D) and (E) are carried out.

Preferred is a method of the present invention, wherein in step (E) the first metalizing composition comprises nickel ions, preferably nickel ions and a reducing agent for reducing said nickel ions, such that the first metal or metal alloy layer is a nickel or nickel alloy layer, respectively. Thus, the first metallized substrate is preferably a first nickel or nickel alloy metallized substrate.

Preferred is a method of the present invention, wherein in step (E) the first metalizing composition is alkaline, preferably has a pH ranging from 8.0 to 11.0, preferably from 8.2 to 10.2, more preferably from 8.4 to 9.3, most preferably from 8.6 to 9.0. However, in some rare cases, a method of the present invention is preferred, wherein in step (E) the first metalizing composition is alternatively acidic, preferably weakly acidic, most preferably has a pH ranging from 6 to 6.9.

Preferred is a method of the present invention, wherein in step (E) the first metalizing composition has a temperature ranging from 18° C. to 60° C., preferably from 20° C. to 55° C., even more preferably from 23° C. to 50° C., most preferably from 26° C. to 45° C.

Preferably, the first metallized substrate is subsequently further metallized.

Preferred is a method of the present invention additionally comprising after step (D) or (E), the step
(F) contacting the activated substrate or the first metallized substrate with a second metalizing composition such that a second metal or metal alloy layer is deposited thereon resulting in a second metalized substrate.

If step (F) follows step (D), step (E) is preferably omitted and the second metalizing composition basically corresponds to the first metalizing composition. However, this is less preferred. More preferably steps (E) and (F) are carried out consecutively. This does not exclude a rinsing step.

Most preferably, step (F) allows a high flexibility regarding how to specifically proceed. This is a great benefit of the method of the present invention. At least two alternatives are possible.

In a first alternative, preferred is a method of the present invention, wherein in step (F) the second metalizing composition comprises copper ions, preferably in a concentration ranging from 0.002 mol/L to 0.4 mol/L, based on the total volume of the second metalizing composition, more preferably ranging from 0.004 mol/L to 0.25 mol/L, even more preferably ranging from 0.005 mol/L to 0.1 mol/L, most preferably ranging from 0.007 mol/L to 0.04 mol/L. Most preferably, the copper ions are copper (II) ions.

More preferred is a method of the present invention in the first alternative, wherein the second and metalizing composition is acidic, preferably has a pH of 2 or below, preferably of 1 or below.

More preferred is a method of the present invention in the first alternative, wherein the second metalizing composition comprises at least one acid, preferably at least one inorganic acid, more preferably at least sulfuric acid. Preferably the at least one acid (more preferably the at least one inorganic acid, most preferably the at least sulfuric acid) has a total concentration ranging from 0.001 mol/L to 0.5 mol/L, based on the total volume of the second metalizing composition, preferably ranging from 0.003 mol/L to 0.3 mol/L, more preferably ranging from 0.005 mol/L to 0.1 mol/L, most preferably ranging from 0.007 mol/L to 0.07 mol/L.

More preferred is a method of the present invention in the first alternative, wherein the second metalizing composition has a temperature ranging from 20° C. to 50° C., preferably ranging from 22° C. to 45° C., more preferably ranging from 24° C. to 40° C., most preferably ranging from 25° C. to 35° C.

More preferred is a method of the present invention in the first alternative, wherein the second metalizing composition is substantially free of, preferably does not comprise, a reducing agent for copper ions.

Most preferred is a method of the present invention in the first alternative, wherein the second metalizing composition is an immersion copper composition. Thus, the copper ions are not reduced to metallic copper by means of a reducing agent. This is also known as replacement plating.

In a second alternative, preferred is a method of the present invention, wherein in step (F) the second metalizing composition comprises nickel ions.

More preferred is a method of the present invention in the second alternative, wherein the second metalizing composition is substantially free of, preferably does not comprise, a reducing agent for nickel ions.

More preferred is a method of the present invention in the second alternative, wherein the second metalizing composition is acidic, preferably has a pH ranging from 1.0 to 5.0, preferably from 2.0 to 4.5, more preferably from 2.8 to 4.0, most preferably from 3.3 to 3.7.

More preferred is a method of the present invention in the second alternative, wherein the second metalizing composition has a temperature ranging from 25° C. to 70° C., preferably from 35° C. to 65° C., even more preferably from 45° C. to 61° C., most preferably from 52° C. to 58° C.

More preferred is a method of the present invention in the second alternative, wherein the contacting is carried out for a time ranging from 1 minute to 10 minutes, preferably from 2 minutes to 8 minutes, most preferably from 2.5 minutes to 5.5 minutes.

More preferred is a method of the present invention in the second alternative, wherein an electrical current is applied, preferably ranging from 0.3 A/dm² to 10.0 A/dm², preferably ranging from 0.5 A/dm² to 8.0 A/dm², more preferably ranging from 0.8 A/dm² to 6.0 A/dm² even more preferably ranging from 1.0 A/dm² to 4.0 A/dm², most preferably ranging from 1.3 A/dm² to 2.5 A/dm². Thus, the second alternative is preferably an electrolytic nickel deposition.

More preferred is a method of the present invention in the second alternative, wherein the second metalizing composition comprises chloride ions and/or (preferably and) boric acid.

Most preferred is a method of the present invention in the second alternative, wherein the second metalizing composition is a Watts Nickel composition. Thus, preferred is a method of the present invention in the second alternative, wherein the second metalizing composition comprises chloride ions, sulfate ions, and boric acid.

After step (F), the second metallized substrate is preferably further metallized.

Preferred is a method of the present invention additionally comprising after step (F) the step
(G) contacting the second metalized substrate with a third metalizing composition such that a third metal or metal alloy layer is electrolytically deposited thereon resulting in a third metalized substrate.

Preferred is a method of the present invention, wherein the third metalizing composition comprises copper ions, preferably in a concentration ranging from 0.05 mol/L to 3 mol/L, based on the total volume of the third metalizing composition, more preferably ranging from 0.1 mol/L to 2 mol/L, even more preferably ranging from 0.2 mol/L to 1.5 mol/L, most preferably ranging from 0.3 mol/L to 1 mol/L.

Preferred is a method of the present invention, wherein in step (G) an electrical current is applied, preferably a direct current.

More preferred is a method of the present invention, wherein the third metalizing composition is acidic or alkaline. In this context, the acidic third metalizing composition represents a first alternative; the alkaline third metalizing composition a second alternative, wherein the first alternative is more preferred in the context of the present invention because it provides very good results in combination with plastic substrates.

More preferred is a method of the present invention, wherein the third metalizing composition according to the first alternative has a pH of 2 or less, preferably of 1 or less.

More preferred is a method of the present invention, wherein the third metalizing composition according to the first alternative comprises at least one acid, preferably at least one inorganic acid, most preferably at least sulfuric acid. Preferably the at least one acid (more preferably the at least one inorganic acid, most preferably the at least sulfuric acid) has a total concentration ranging from 0.1 mol/L to 5 mol/L, based on the total volume of the second metalizing composition, preferably ranging from 0.2 mol/L to 3 mol/L, more preferably ranging from 0.3 mol/L to 2 mol/L, most preferably ranging from 0.4 mol/L to 1.5 mol/L.

More preferred is a method of the present invention, wherein the third metalizing composition according to the first alternative comprises chloride ions, preferably chloride ions in a total concentration of 500 mg/L or less, preferably 300 mg/L or less, most preferably 150 mg/L or less.

More preferred is a method of the present invention, wherein the third metalizing composition according to the first alternative has a temperature ranging from 20° C. to 49° C., preferably ranging from 22° C. to 43° C., more preferably ranging from 24° C. to 39° C., most preferably ranging from 26° C. to 35° C.

More preferred is a method of the present invention, wherein the third metalizing composition according to the second alternative has a pH ranging from 7.1 to 12, preferably ranging from 7.4 to 11, most preferably ranging from 7.6 to 10.

More preferred is a method of the present invention, wherein the third metalizing composition according to the second alternative comprises cyanide ions or pyrophosphate ions, preferably pyrophosphate ions.

More preferred is a method of the present invention, wherein the third metalizing composition according to the second alternative has a temperature ranging from 50° C. to 70° C.

In the context of the present invention, the terms first, second, and third metalized substrate denotes a correspondence to the respective step as defined above in the text, rather than a numerical amount/number of metalized substrates.

Preferred is a method of the present invention, wherein after step (G) the third metallized substrate is contacted with one or more than one further metalizing composition, wherein at least one thereof comprises trivalent chromium ions such that a chromium or chromium alloy metal layer, respectively, is deposited.

Most preferably, the chromium or chromium alloy metal layer, respectively, is the outermost metallic layer. Thus, most preferably the method of the present invention is for metalizing a plastic substrate, wherein the metalizing comprises a chromium deposition, preferably a decorative chromium deposition.

In the context of the present invention, preferably a sequence of steps, in particular of metallization steps, is defined. Preferably, this does not exclude intermediate steps in between those steps, such as rinsing steps. Thus, preferred is a method of the present invention, wherein at least between one of the steps (B), (C), and preferably (D) to (G) an intermediate step is carried out, most preferably a rinsing step.

### EXAMPLES

The invention will now be illustrated by reference to the following non-limiting example.

In step (A) of the method of the present invention, a plurality of non-metallic plastic substrates (ABS and ABS-PC, each having surface dimensions ranging from 0.1 dm² to 10 dm²) was used.

Prior to contacting the substrates with the etching composition, they were pre-treated in step (B) by contacting them with a cleaning solution (Uniclean 151, product of Atotech). No swelling or swelling composition was utilized and needed, respectively. Thus, no contacting with an organic solvent was involved.

After step (B) and a rinsing, the pre-treated substrates were etched in step (C) in respective etching compositions (40° C.) as summarized in Table 1.

After step (C) an etch pattern was obtained which was further investigated by microscopy, showing a sponge-like structure highly similar to a typical etch pattern obtained after etching with chromic acid. Own analysis confirmed that in the substrates primarily the polybutadiene framework was etched wherein the acrylonitrile styrene of the substrates remained mostly intact.

After step (C) a rinsing was carried out with water. If any manganese species remained on the substrate's surfaces, they were simply rinsed away with water since no strong adherence of them (including manganese dioxide) is observed.

In step (D) the etched substrates were contacted with an activation composition comprising colloidal palladium (approximately: 50 mg/L Pd, temperature 40° C., contact time 5 minutes) to obtain activated substrates.

Prior to step (E) a rinsing was carried out with water.

In step (E) the activated and rinsed substrates were contacted with the first metalizing composition in order to obtain a first metalized substrate. The activated substrate was contacted with an alkaline (pH approximately 8.6 to 9.0) first metalizing composition (having a temperature of approximately 26° C. to 45° C.; contact time about 10 minutes) for electroless nickel plating. The first metalizing composition comprised approximately 3.5 g/L nickel ions and approximately 15 g/L hypophosphite ions as a reducing agent for nickel ions to obtain nickel alloy-metallized substrates.

In step (F), the nickel alloy-metallized substrates were contacted for approximately 0.5 to 5 min with an acidic second metalizing composition comprising nickel sulfate, nickel chloride, and boric acid (Watts-Nickel composition; pH approximately 3.3 to 3.7; temperature 55° C., current density approximately 1.5 A/dm²) or copper sulphate and sulfuric acid (electroless metallization without reducing agent, Immersion Copper composition; pH<1). Thus, step (F) is an electrolytic deposition of nickel or an electroless immersion deposition of copper (copper replacement plating). For most of the substrates both was tested (see Table 1 below).

Afterwards, the second metalized substrates with the second metal or metal alloy layer were rinsed with water.

In step (G), after rinsing, the respective substrates were contacted with a third metalizing composition (acidic pH) in order to obtain a third metalized substrate having a copper layer with a layer thickness of more than 30 μm (contact time about 45 min, 32.5° C., 40 g/L copper ions; electrolytic copper plating).

Subsequently, further metallization steps were carried out to deposit a chromium layer. The metalized substrates having a copper layer with a layer thickness of more than 30 μm were subjected to at least one more nickel plating.

In a final metallization step, the respective substrates were contacted with a further metalizing composition in order to obtain a metalized substrate having a chromium layer, the further metalizing composition comprising 15 g/L to 30 g/L trivalent chromium and boric acid (acidic pH, 25° C. to 60° C.).

Finally, the optical quality of the chromium layer was evaluated by analyzing coverage and optical defects, in particular blisters. As a result, no haze and no other optical defects were observed, in particular no blisters. In particular, the chromium layer showed a very homogeneous optical distribution.

For adhesion tests, the substrates obtained after step (G) (i.e. plated with copper) were subjected to adhesion tests. The adhesion values for ABS and ABS-PC are summarized in Table 1 below for each case, immersion copper plating as well as Watts nickel plating.

Table 1, adhesion values on ABS and ABS/PC for different etching compositions at 40° C.

| | | | | Etching | | |
|---|---|---|---|---|---|---|
| | c(H₃PO₄) | c(MnO₄⁻) | | time | Adhesion* | Adhesion** |
| No. | [M] | [mM] | substrate | [min] | [N/mm] | [N/mm] |
| 1 | 10.7 | 5.8 | ABS | 8 | 1.1 | 1.19 |
| 2 | 10.7 | 5.8 | ABS/PC | 20 | 0.53 | 0.47 |
| 3 | 10.7 | 15.4 | ABS | 8 | na | 1.35 |
| 4 | 10.7 | 15.4 | ABS/PC | 20 | 0.52 | na |
| 5 | 10.0 | 9.7 | ABS | 8 | na | 1.06 |
| 6 | 10.0 | 9.7 | ABS/PC | 20 | 0.54 | Na |
| 7 | 10.0 | 15.4 | ABS | 8 | 1.09 | 0.97 |
| 8 | 10.0 | 15.4 | ABS/PC | 20 | 0.63 | 0.51 |
| 9 | 8.8 | 9.7 | ABS | 8 | 1.01 | 1.27 |
| 10 | 8.8 | 9.7 | ABS/PC | 20 | 0.49 | 0.49 |
| 11 | 8.8 | 19.4 | ABS | 8 | 0.89 | 1.69 |
| 12 | 8.8 | 12.9 | ABS/PC | 20 | na | 0.56 |

*denotes substrates treated with immersion copper
**substrates treated with Watts nickel

Table 1 shows that ABS and ABS-PC substrates can be efficiently and successfully etched. Further substrates, such as polypropylene (PP), 2K-substrates (PC/ABS as well as PC/ABS-PC), and 3K-substrates comprising rubber were likewise efficiently and successfully etched (data not shown). For PC/ABS and PC/ABS-PC only the ABS and the ABS-PC, respectively, was selectively etched without etching the polycarbonate (PC) component.

The present examples show and confirm that substrates can be etched in such a way that in subsequent metallization steps either a nickel metallization (e.g. Watts nickel) or copper metallization (e.g. immersion copper) can be applied alike. This allows a great flexibility in further process steps. Adhesion values are very similar; no blisters were observed before and after chromium plating.

Regarding Table 1, for ABS typically an adhesion of about 0.9 N/mm is very acceptable and desired; Examples 3, 9, and 11 show in particular desired adhesion values. For ABS-PC typically an adhesion of about 0.5 N/mm is very acceptable and desired.

In some examples the experimental setup was modified in such a way that a regeneration compartment was included (data not shown). For that, manganese species having an oxidation number below +7 were constantly treated into the regeneration compartment and reoxidized by an electrical current to permanganate ions. These permanganate ions were replenished into the etching composition. This modified setup did not negatively affect the adhesion but rather allows a significant long term-utilization of the etching composition. In this case, silver ions were additionally utilized.

Further examples at slightly lower and slightly higher concentrations for phosphoric acid also provided acceptable results as long as the concentration is not below 7 mol/L or exceeding 12 mol/L (data not shown); below and above these values no suitable etching results for the low permanganate concentration range used in the context of the present invention were obtained. In particular, an etching composition as disclosed in EP 2 025 708 A1 (see example therein with a phosphoric acid concentration significantly exceeding 12 mol/L) shows a too strong acid concentration, which is highly destabilizing the low permanganate concentration as used in the present invention. Despite an undesired etching result, this is furthermore very undesired if for example a regeneration compartment is utilized. In such a case an undesired high amount of energy is consumed for the re-oxidation and the re-oxidation is not as efficient as defined for the parameters in the context of the present invention.

In a further set of examples with again a temperature of 40° C. in step (C), step (C) additionally comprised step (C-1), wherein a regeneration compartment and an electrical current was utilized with a current density of approximately 1 A/dm². The results are summarized in Table 2 below. In contrast, experiments according to Table 1 were carried out based on a feed and bleed approach.

Table 2, adhesion values on ABS and ABS/PC for different etching compositions at 40° C. with electrolytic re-oxidation

| | c(H₃PO₄) | c(MnO₄⁻) | | Etching time | Adhesion* |
|---|---|---|---|---|---|
| No. | [M] | [mM] | substrate | [min] | [N/mm] |
| 13 | 10.6 | 9.3 | ABS | 5 | 1.29 |
| 14 | 10.6 | 9.3 | ABS/PC | 15 | 0.69 |
| 15 | 10.6 | 10.0 | ABS | 3 | 1.00 |
| 16 | 10.6 | 10.0 | ABS/PC | 10 | 0.72 |
| 17 | 10.6 | 6.9 | ABS | 8 | 1.29 |
| 18 | 10.6 | 7.3 | ABS/PC | 20 | 0.72 |
| 19 | 10.6 | 7.3 | ABS | 5 | 1.57 |
| 20 | 10.6 | 7.3 | ABS/PC | 15 | 0.66 |

*denotes substrates treated with immersion copper

Table 2 indicates that a regeneration by means of an electrical current, typically results in a more efficient etching.

For example, examples 5 and 15 relate to the etching of ABS substrates and provide an almost identical concentration for H₃PO₄ and MnO₄^{—}. Example 5, following a feed and bleed approach, requires 8 minutes to achieve a very acceptable adhesion of about 1 N/mm. In contrast, example 15, following an electrolytic regeneration, requires only 3 minutes to achieve a very similar result. This is a reduced etching time of more than 50%.

This is also confirmed for ABS/PC. For example, example 6 requires an etching time of 20 minutes to achieve an adhesion of about 0.5 N/mm, wherein example 16 requires only 10 minutes to achieve an even increased adhesion of even more than 0.5 N/mm. Again, the etching time is significantly reduced.

1. A method for etching at least one surface of a plastic substrate, the method comprising the steps
(A) providing the substrate,
(B) optionally, contacting the provided substrate with one or more than one pre-treatment composition,
(C) contacting the substrate obtained after step (A) or (B) with an etching composition such that an etched substrate results, the etching composition comprising
(a) water,
(b) 0.0025 mol/L to 0.1 mol/L permanganate ions,
(c) 7 mol/L to 12 mol/L phosphoric acid,
(d) 0 to 0.1 mol/L silver (I) ions, and
(e) 0 or less than 10 ppm manganese (II) ions,
wherein at least during step (C) at least a portion of the permanganate ions is converted into manganese species having an oxidation number below +7.

2. The method of claim 1, wherein step (B) does not comprise a contacting with a pre-treatment composition comprising an organic solvent.

3. The method of claim 1, wherein step (C) further comprises step (C-1) replenishing permanganate ions to the etching composition utilized in step (C).

4. The method of claim 3, wherein
at least a portion of the manganese species having an oxidation number below +7 is treated in a regeneration compartment and an electrical current is applied such that they are re-oxidized to permanganate ions, and
permanganate ions replenished in step (C-1) are those re-oxidized in the regeneration compartment.

5. The method of claim 3, wherein
at least a portion of the manganese species having an oxidation number below +7 is removed from the etching composition by removing at least a portion of the etching composition, and
permanganate ions replenished in step (C-1) are from an alkali permanganate salt.

6. The method of claim 1, wherein in the etching composition the permanganate ions have a concentration ranging from 0.004 mol/L to 0.09 mol/L.

7. The method of claim 1, wherein in the etching composition the phosphoric acid has a concentration ranging from 7.4 mol/L to 11.8 mol/L.

8. The method of claim 1, wherein in the etching composition all manganese species together have a total concentration ranging from 0.02 mol/L to 0.3 mol/L, based on the total volume of the etching composition.

9. The method of claim 1, wherein the etching composition is substantially free of fluorinated surfactants, and is substantially free of fluorinated organic compounds.

10. The method of claim 1, wherein during step (C) the etching composition has a temperature ranging from 25° C. to 60° C.

11. The method of claim 1,
additionally comprising after step (C), the step (D), step (E) or both step (D) and step (E):
step (D) contacting the etched substrate with an activation composition such that an activated substrate is obtained;
step (E) contacting the etched substrate or the activated substrate with a first metalizing composition such that a first metal or metal alloy layer is deposited thereon resulting in a first metalized substrate.

12. The method of claim 11 additionally comprising after step (D) or (E) or both step (D) and step (E), step (F) contacting the activated substrate or the first metallized substrate with a second metalizing composition such that a second metal or metal alloy layer is deposited thereon resulting in a second metalized substrate.

13. The method of claim 12, wherein in step (F) the second metalizing composition comprises copper ions.

14. The method of claim 12, wherein in step (F) the second metalizing composition comprises nickel ions.

15. The method of claim 12 additionally comprising after step (F), step (G) contacting the second metalized substrate with a third metalizing composition such that a third metal or metal alloy layer is electrolytically deposited thereon resulting in a third metalized substrate.
